(19) United States
(12) Patent Application Publication
(10) Pub. No.: US 2018/0362113 A1
(43) Pub. Date: Dec. 20, 2018

(54) CRANK ARM DRIVE REGULATING MECHANISM

(71) Applicant: Franklin J. DAY, Walnut Creek, CA (US)

(72) Inventor: Franklin J. DAY, Walnut Creek, CA (US)

(21) Appl. No.: 16/013,516

(22) Filed: Jun. 20, 2018

Related U.S. Application Data
(60) Provisional application No. 62/522,572, filed on Jun. 20, 2017.

(51) Int. Cl. B62M 1/36

(52) U.S. Cl. CPC B62M 1/36

(57) ABSTRACT

A drive mechanism for connecting a crank arm of a bicycle crankset or the like to a crankshaft, in a selected one of at least two modes. In one available mode, a crank arm is oriented to the crankshaft at a fixed angle about the axis of rotation of the crankshaft. In another available mode, a crank arm can be rotated freely about the crankshaft in a first direction but is connected drivingly to the crankshaft by a pawl so as to rotate the crankshaft in an opposite second direction. In a third available mode, the pedal crank arm is free to rotate in either direction with respect to the crankshaft through a limited angle of rotation beyond which a pawl in one member of the drive mechanism will engage another member and cause the crank arm to rotate the crankshaft.

### BACKGROUND OF THE INVENTION

The present application is related to crank driven machines such as bicycles and crank-driven exercise machines and relates particularly to a clutch system for interconnecting a crank with a driven shaft so as to optionally permit a degree of angular freedom of motion between the crank and the shaft that it is arranged to rotate or drive.

Freewheel mechanisms, basically ratchet and pawl mechanisms, are well known and widely used in connecting a drive sprocket to the driven wheel, usually the rear wheel, of a bicycle or in reversible ratchet wrenches.

It is also known to incorporate a one-way clutch mechanism in a pedal crank to drive a spindle connected to drive a front sprocket, or chain ring, of a bicycle, as taught in Day U.S. Pat. No. 5,860,329. Day et al. U.S. Pat. No. 7,607,370 discloses a mechanism by which a crank can be connected to drive a shaft optionally in either a bidirectional driving mode or in a unidirectional driving mode. Day US Patent Application Publication No. 2010/0167881 discloses a mechanism for connecting a crank drivingly to a shaft and permitting selection of various angular amounts of freedom of rotation of the crank with respect to the shaft.

When a cyclist is training for competitive cycling, particularly for road racing, it may prove beneficial to provide some angular freedom of movement of a crank relative to the shaft it is intended to drive, to provide a feedback mechanism in order to habituate the cyclist to continuously apply forward torque through both of a pair of pedals driving the chain rings of a bicycle. When the cyclist fails to apply forward torque continuously, the mechanisms mentioned above can provide immediate and unmistakable feedback to alert the cyclist to the need for improved technique.

The mechanism disclosed in U.S. Pat. No. 5,860,329, while providing such feedback, can result in some difficulty in reaching a normal coordinated configuration of a pair of bicycle cranks in positions separated by an angle of 180° about the crank shaft. As a result, the mechanism acts as a very strict teacher. Additionally, the mechanism disclosed in that patent does not incorporate a simple override by which the cranks can be made to function as conventional cranks without such a one-way clutching action. This presents two problems, it could be dangerous to use the one-way cranks in some situations (such as technical off-road riding) and it is illegal to use the one-way cranks in some types of races where the rules require the rider to be able to also pedal backwards to slow or stop the bicycle (track racing).

What is desired, then, is a drive mechanism by which a crank can be connected to drive a shaft substantially without angular freedom of motion with respect to the shaft, or with a selected amount of angular freedom of motion with respect to the shaft together with the ability to return to a selected angular driving orientation to the shaft, or with the ability to engage the shaft drivingly in any of multiple angular orientations with respect to the shaft and to be able to make this change quickly and easily.

### SUMMARY OF THE INVENTION

A drive mechanism embodying the invention disclosed herein provides an answer to the need explained above for a drive mechanism useful for training cyclists and by which a crank arm can be connected drivingly to a shaft in a selected one of at least two different modes.

A drive mechanism which is one embodiment of the invention may be operated in a selected one of a plurality of modes, including one mode in which the crank arm has a certain amount of angular freedom of rotation with respect to a shaft to be driven by the crank arm, but can drive the shaft in either direction.

In one embodiment, the drive mechanism includes an optionally available mode in which the drive mechanism can connect the crank arm drivingly to the shaft substantially without any angular freedom of rotation with respect to the shaft.

In one embodiment, the drive mechanism includes an optionally available mode in which the crank arm can be rotated freely without driving the shaft in one direction but will engage the shaft drivingly in the opposite direction of rotation.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is an isometric view of a crank arm and an associated drive mechanism by which the crank arm can be connected to drive a crank shaft yet have a selected one of a plurality of different amounts of angular freedom to rotate about the crankshaft.

FIG. 2 is an exploded isometric view of the crank arm and drive mechanism shown in FIG. 1.

FIG. 3 is an exploded isometric view of the crank arm and drive mechanism shown in FIGS. 1 and 2 as seen from the opposite end.

FIG. 4 is a sectional view of the crank arm and drive mechanism shown in FIGS. 1-3, taken in the direction indicated by the line 4-4 in FIG. 1.

FIG. 5 is a perspective view, at an enlarged scale, of one of the pawls shown in FIGS. 2-4.

FIG. 6 is a view of a portion of the assembled drive mechanism without the shaft adapter, with portions shown in section view, taken along sectional lines 6-6 in FIG. 4, and showing only portions of the control collar, with the control collar in a first position in which the crank is free to rotate in one direction with respect to the driven member, but pawls in the driven member engage the driving member so that further rotation of the crank will rotate the driven member.

FIG. 7 is a view similar to FIG. 6, but with the control collar in a second position in which the driving member is free to rotate with respect to the driven member through a very limited angle in either direction and upon further rotation engages the driven member drivingly.

FIG. 8 is a view similar to FIGS. 6 and 7, with the control collar in the second position and the driven member in a different position with respect to the driving member from that shown in FIG. 7, in which the driving member is free to rotate with respect to the driven member through a larger angle in either direction and upon further rotation engages the driven member drivingly.

FIG. 9 is an exploded isometric view of a second embodiment of the crank arm and drive mechanism shown in FIGS. 1-8.

FIG. 10 is an exploded isometric view of the crank arm and drive mechanism shown in FIG. 9, as seen from a different point of view.

### DETAILED DESCRIPTION OF PREFERRED EMBODIMENTS

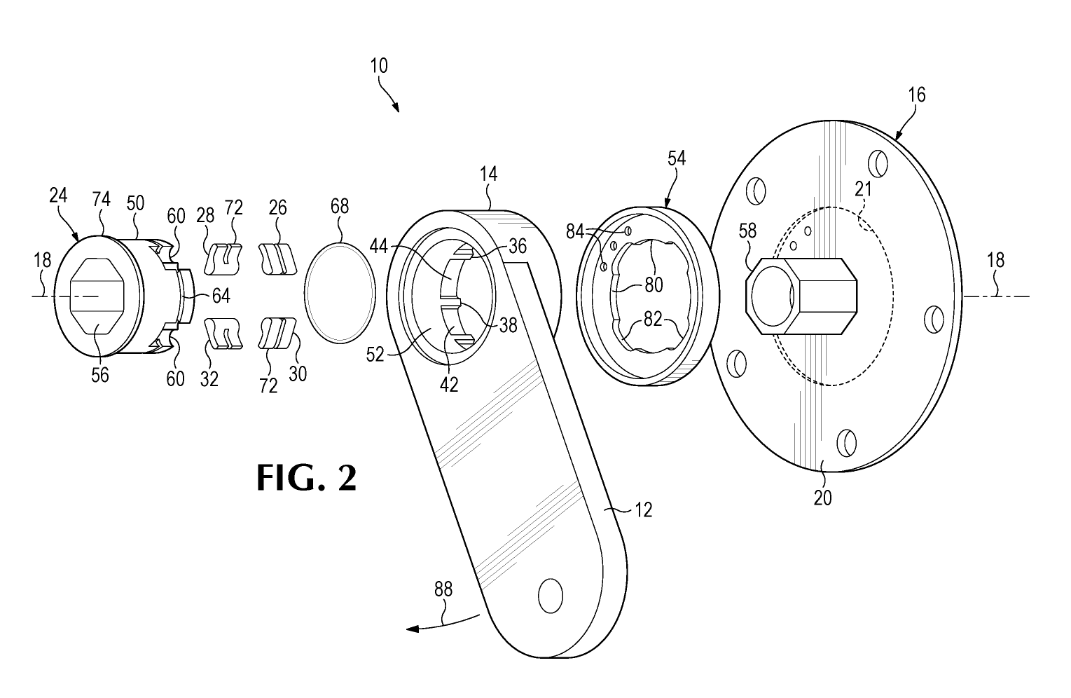

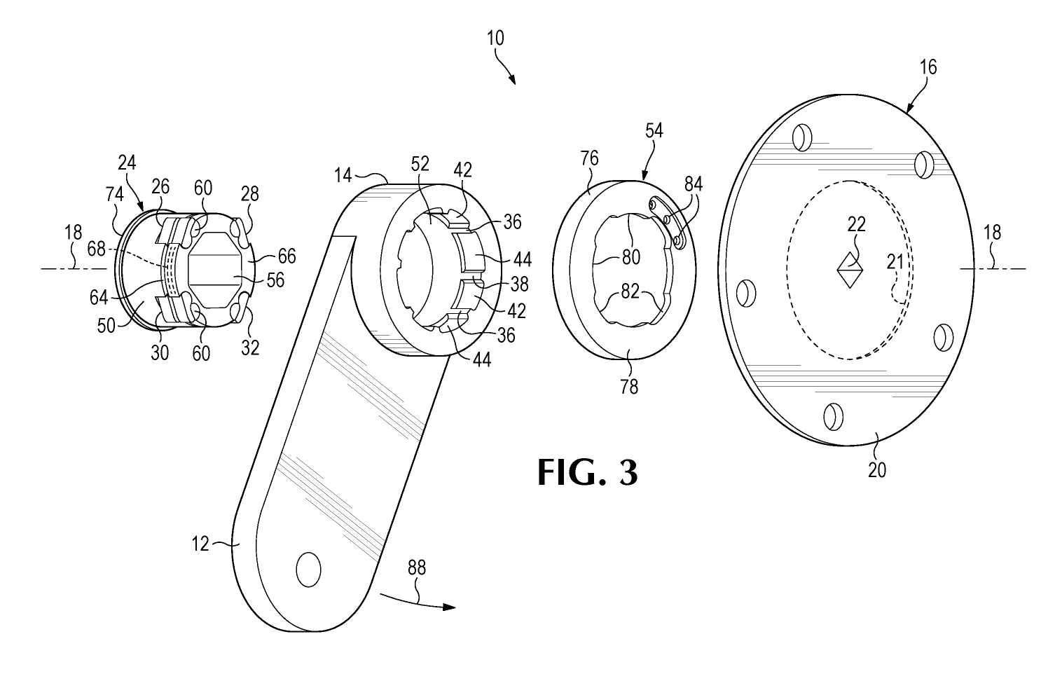

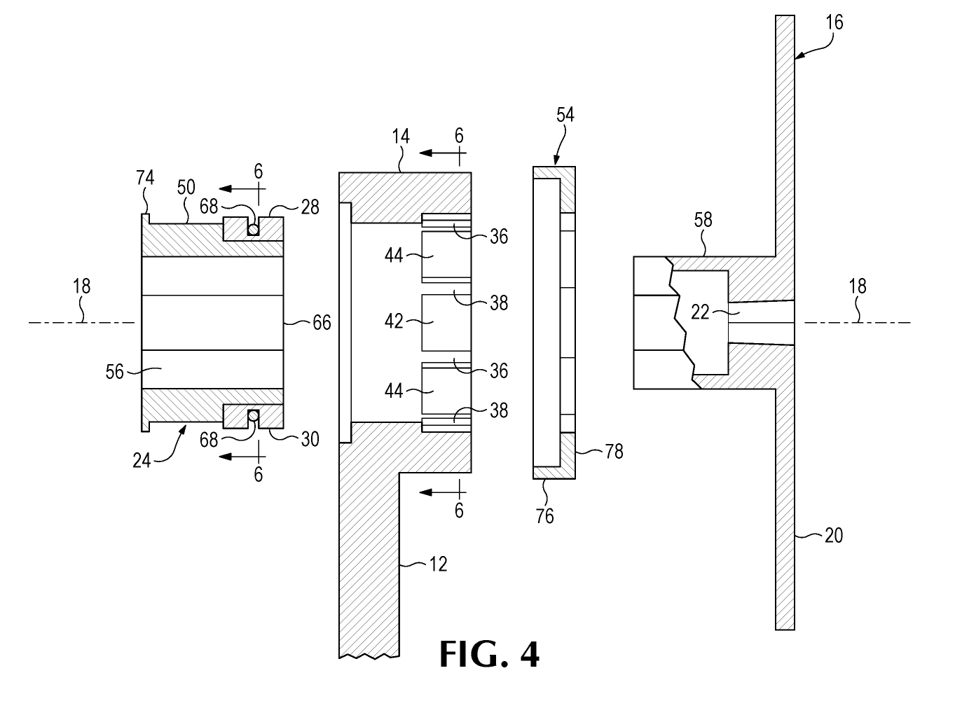

Referring now to the drawings which form a portion of the disclosure herein, a shaft drive mechanism 10 is associated with a crank arm 12 which may be one of a pair of crank arms of a bicycle crankset (not shown) and which is fixedly mounted on a driving member 14 of the shaft drive mechanism 10 which is a preferred embodiment of the drive mechanism disclosed herein. The shaft drive mechanism 10 enables the crank arm 12 to drive a shaft drive adaptor 16 about an axis of rotation 18. The shaft drive adaptor 16 may include a flange 20 extending radially beyond the broken line 21 in FIGS. 2 and 3, designed to receive a chain ring or a set of chain rings (not shown). Alternatively, a corresponding shaft drive adaptor (not shown) may have a much smaller flange and simply include an appropriately shaped shaft-driving receptacle, such as the tapered square hole 22 defined in the shaft drive adapter 16 as may be seen in FIGS. 3 and 4, or a different receptacle designed to mate with a differently configured end of a crank shaft.

In the shaft drive mechanism 10 shown herein a driven member 24 is located concentrically within the driving member 14 and is connected selectively to the driving member 14 through a plurality of pawls 26, 28, 30, and 32 and respective driving cogs 36 and 38 defined at respective ends of a set of receptacles in the form of enlargements of the interior of the driving member 14 extending circumferentially of the interior of the driving member 12. The receptacles, or enlargements, are, for the sake of convenience, referred to herein as drive notches 42 and 44. The driving cogs 36 and 38 function similar to the teeth of a ratchet portion of a ratchet and pawl combination, but are arranged in the drive mechanism 10 to permit driving the driven member in either direction of rotation rather than in a single direction as is usual in a ratchet.

The driven member 24 may include a journal portion 50 received in a corresponding bearing sleeve portion 52 that may be incorporated in the driving member 14. Alternatively, other bearing arrangements may be included to permit the driven member 24 to rotate freely and without wobbling with respect to the driving member 14 when none of the pawls 26, 28, etc. is engaged with any of the driving cogs 36 and 38.

A control member 54, shown herein in the form of a collar, is associated with the driven member 24 to control the manner in which one or more of the pawls 26, 28, 30, and 32 is free to move into or out of a position of engagement with a respective one of the driving cogs 36 and 38.

The driven member 24 may include a receptacle 56 for the drive adaptor 16, for example defining the octagonal interior shape shown in FIGS. 3 and 4 in which a corresponding octagonal hub 58 of the drive adaptor 16 fits matingly so as to be driven and thus to drive a shaft such as the crankshaft, or spindle, of a bicycle crankset. Referring more particularly to FIGS. 2-4, the driven member 24 may include at least two and preferably more pawl receptacles 60, each of which may be shaped to receive one of the pawls 26, 28, etc., oriented so as to ratchet in one of the two possible directions of rotation. Each of the pawls 26, 28, etc., may include a centrally located slot or groove 62 defining a plane perpendicular to the axis of rotation 18, and the driven member defines a circumferential groove 64 in the same plane. That is, the groove 64 in the driven member is located so that when the pawls 26, 28, 30, and 32 are in place in respective ones of the pawl receptacles 60 the grooves 62 and 64 are aligned with one another.

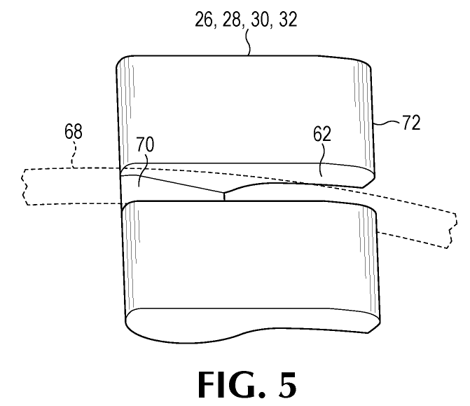

A spring 68, which may be a long helical spring with its opposite ends interconnected to form a loop, or which may merely be a loop of an elastic material similar to a rubber band, extends around all of the pawls 26, 28, 30, and 32, within the groove 64 and along and through the groove 62 of each pawl, and in a small amount of tension. The bottom 70 of the groove 62 in each pawl 26, etc., is shaped and oriented to act as a lever, as may be seen more clearly in FIG. 5, so that radially inward pressure of the spring 68 with respect to the driven member urges each pawl 26, 28, etc. to rotate in its receptacle 60 so that its outer end 72 will move radially outward beyond the circumference of the driven member 24 into one of the drive notches 42 or 44 defined within the driving member 24. Alternatively, a separate spring (not shown) having a different configuration could be associated with each pawl 26, 28, etc., to urge it to rotate in the same manner with respect to its receptacle 60.

At least two pawls 26 and 28 are mounted in the inner end 66 of the driven member 24, and at least one pawl should be oriented opposite at least one other one of the pawls. As shown in FIGS. 3, 6, 7, and 8 pawls 26 and 32 are oriented similarly and pawls 28 and 30 are both oriented in the opposite direction of rotation. In assembling the driving mechanism 10, the pawls 26, 28, 30, and 32 may all be installed in the driven member 24, with the spring 68 extending around the driven member 24 within the grooves 62 and 64. The outer ends 72 of the pawls may be depressed and held temporarily in such a way that the outer ends 72 are not free to protrude radially beyond the circumference of the driven member 24 while the driven member and the pawls are inserted into the driving member 24 from its outer end. A flange 74 may be provided on the outer end of the driven member 24 to limit axial movement of the driven member 24 and to establish its position relative to the driving member 14 along the axis of rotation 18. With the driven member 24 installed within the driving member 14 each pawl extends axially beyond the driving member a small distance.

The control member 54 includes a portion that is available to be gripped so that the control member 54 can be rotated with respect to both the driving and driven member. For example, the control member 54 may, as shown, incorporate a sleeve portion 76 that fits around the circumference of the driving member 14 and is available to be gripped to rotate the control member 54 with respect to the driven member 24.

A planar portion 78 of the control member 54 extends radially inwardly from the sleeve portion 76 adjacent the inner end of the driving member 14 and has an inner margin defining a plurality of cams 80 that, depending upon the position of rotation of the control member 54 with respect to the driven member 24, may press radially inwardly against one or more of the pawls 26, 28, 30, and 32, preventing the outer end 72 of such a pawl from protruding radially outwardly beyond the periphery of the driven member 24 into one of the driving notches 42 and 44 defined in the interior of the driving member 24. Each one of the pawls that is engaged by a cam 80 is thus prevented from engaging any of the driving cogs 36 and 38 of the driving member 14. Spaces 82 between the cams 80 allow the outer end 72 of one of the pawls to protrude radially beyond the periphery of the driven member 24 to engage one of the driving cogs when the control member 54 is in a position in which one of the spaces 82 is aligned with the pawl.

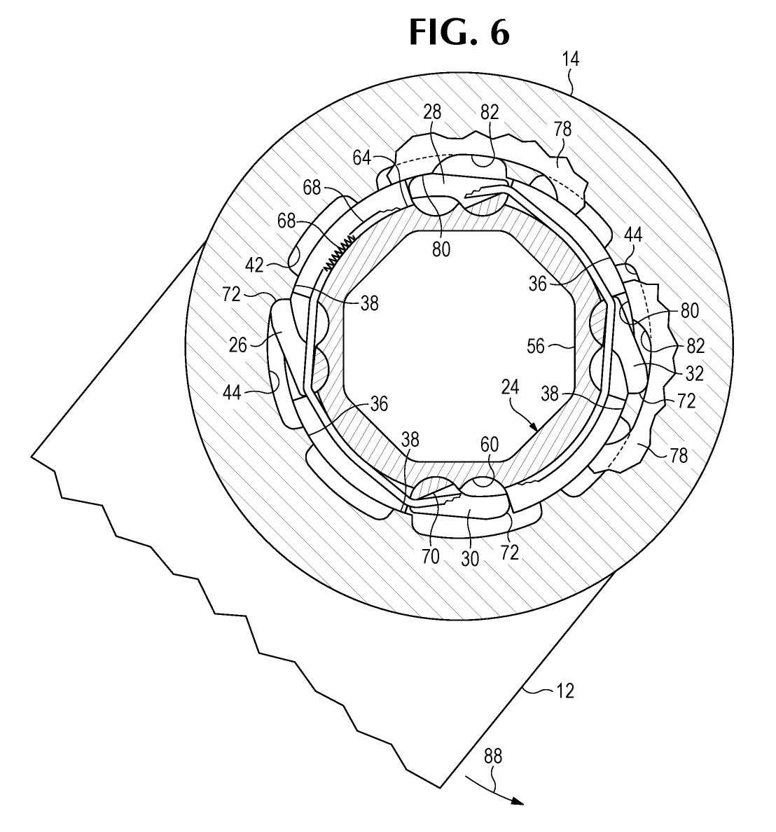

A detent mechanism, such as spring-loaded balls 84 protruding from the planar portion 78 of the control member 54 and a corresponding hole or holes 86 in the opposing flat face of the drive adapter 16 may be provided to hold the control member 54 in a chosen one of at least two different positions of rotation with respect to the driven member 24, as shown in FIGS. 6, 7, and 8.

Thus, as shown in FIG. 6, with the control member 54 in a first position with respect to the driven member 24 and held there by the detent mechanism, a pair of cams 80 of the control member 54 keep the outer ends 72 of the pawls 28 and 30, which are oriented oppositely from the pawls 26 and 32, from protruding radially outward far enough to engage a driving cog 36 or 38 located at an end of any of the driving notches 42 and 44 defined in the driving member 14. With the control member 54 in that position, the pawls 26 and 32 are free to rotate in their respective receptacles 60 so as to have their outer ends 72 protrude into one of the spaces 82 in the portion 78 of the control member 54 and thus also into one of the driving notches 42 and 44 in the driving member 24. As a result, rotation of the crank arm 12, and thus the driving member 14, in a forward direction as indicated by the arrow 88 results in at least one of the pawls 26 and 32 engaging a respective driving cog at the rear end of one of the driving notches in the driving member 14, causing the driven member 24 to rotate in a forward direction. However, the crank arm 12, and thus the driving member 14, is free to rotate in a rearward direction of rotation with respect to the driven member 24. Each of the pawls 26 and 32 rotates in its respective receptacle 60, against the urging of the spring 68, as each of the cogs 36 and 38, in turn, pushes the outer end 72 of each of the pawls 26 and 32 radially inward far enough to clear the respective cog 36 or 38.

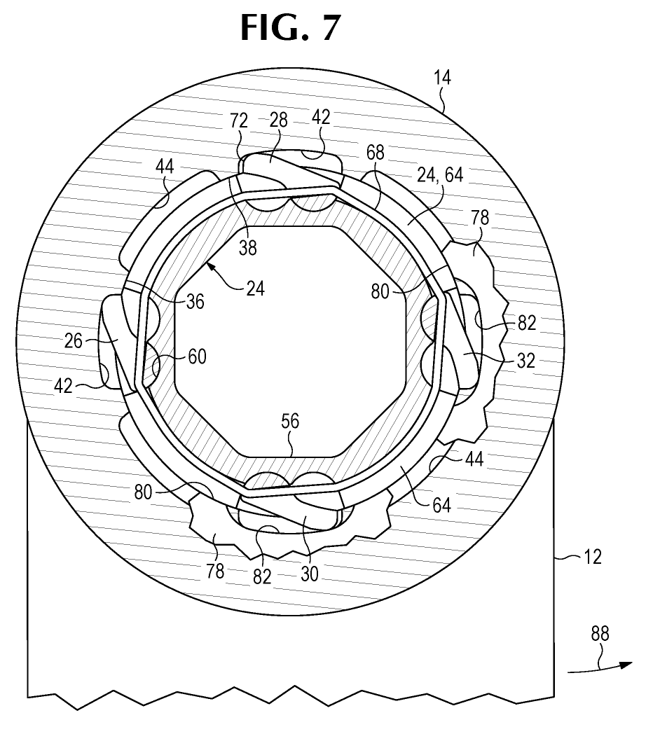

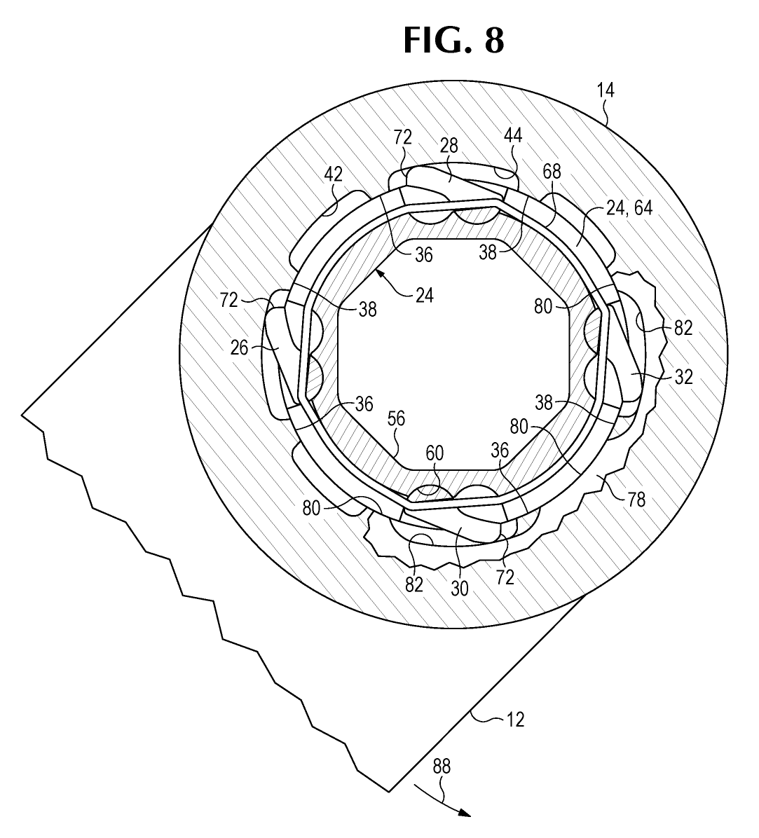

With the control member 54 rotated to a second position with respect to the driven member and held there by the detent mechanism as shown in FIG. 7 and FIG. 8, all of the pawls 26, 28, 30, and 32 are free to rotate in their respective receptacles 60 in the driven member 24 so that their outer ends 72 can protrude into spaces 82 in the portion 78 of the control member 54 and thus also protrude into respective ones of the driving notches 42 and 44. Depending upon the location of the driving member 14 with respect to the driven member 24 when the control member 54 is rotated from the first position, shown in FIG. 6, to that second position, the driving member 14 will be able to rotate freely in either direction with respect to the driven member 24 through an angle defined by the sizes of the driving notches 42 and 44. When the crank arm and thus the driving member is rotated in a rearward direction the outer ends 72 of the pawls 28 and 30 will encounter the driving cog at the forward end of the driving notch, and when the crank arm and thus the driving member is rotated in the opposite, forward direction at least one of the pawls will encounter the driving cog at the rearward end of one of the driving notches.

The driving notches 42, 44 extend over different angular lengths between the driving cogs 36 and 38 at their opposite ends, so when the control member 54 is rotated to the second position with the driving member 14 in the location relative to the driven member 24 as shown in FIG. 7, the pawls 26 and 32 engage driving cogs 36, and with only a very limited amount of rotation of the driving member relative to the driven member, for example 3° or less, the outer ends of the two pawls 28 and 30 would be brought to bear on the cogs 38. Thus, a cyclist using a cycle equipped with this drive mechanism 10 on each crank arm would not be hampered by the small difference from a conventional solid crankset.

Freedom of the driving member to rotate through several degrees of angular movement with respect to the driven member is provided, however, by placing the control member 54 in the second position, shown in FIGS. 7 and 8, when the driving member 14 is in the position shown in FIG. 8 with respect to the driven member 24. This relationship between the driving member 14 and the driven member 24 results in each of the pawls 26 and 32 having their respective outer ends 72 engage one of the driving cogs 38 when the driving member 14 is rotated in a forward direction, (indicated by the arrow 88) and then allows the driving member to be rotated in a rearward direction through an angle of, for example, 10, while the outer ends 72 of those pawls remain in the same driving notches 44. Further rearward rotation of the driving member 14 with respect to the driven member 24 is prevented, however, by engagement of the outer ends 72 of each of the pawls 28 and 30 with the driving cog 36 at the forward end of the driving notch 44. With the driving member 14 engaged with the driven member 24 in that relationship, as shown in FIG. 8, pedaling forward on a bicycle equipped with the drive mechanism 10 will drive the crankshaft forward with the crank arm 12 oriented at a known position with respect to the crankshaft, while allowing the crankshaft to be driven ahead of the desired position of orientation of the crank arm by an angle of a few degrees should the cyclist fail to maintain forward pressure. Later forward rotation of the crank arm 12 will return the crank arm to the normal relationship to the crank shaft.

While this description and the accompanying drawings show the drive mechanism 10 with four pawls and eight driving notches, it will be understood that it would be possible to construct a similar mechanism (not shown) incorporating 12 driving notches to provide three different amounts of freedom of movement of the driving member 14 relative to the driven member 24.

Having a drive mechanism 10 as described above associated with each of the opposite ends of the shaft of a bicycle crankset, the normal opposite orientations of the two crank arms will be regained with no trouble when the cyclist is again pushing both pedals in a forward direction of rotation, but the ability of each crank arm to fall behind the position of rotation of the crankshaft by a small angle will result in a noticeable sensation at the moment when the crank arm 12 catches up with the crankshaft so that the pawls 26 and 32 again engage the driving cogs 36 or 38. The cyclist will thus receive a definite indication that forward pressure has not been maintained throughout a complete crank revolution, but will be able to resume pedaling with the crank arms 12 in their normal opposite orientations with respect to each other.

While the drive mechanism 10 has been described above principally in a configuration of such a drive mechanism for one end of the crankshaft of a bicycle crankset, it will be understood that a similar drive mechanism can be installed at the opposite end of the crankshaft of a bicycle crankset. It will also be that the driving member 14 need not be driven directly by an attached crank arm 12, but could be driven by a shaft that is driven by a crank located at its opposite end, as when a pair of such drive mechanisms 10 may be installed in a hand cranked machine where a pair of crank arms are desired to be separated by a greater distance axially along the axis of rotation 18 of the machine.

Similarly, it will be understood that the drive mechanism 10 could be assembled with a driving member located concentrically within a driven member, and a suitable adaptor could be utilized to connect the driven member with a shaft to be driven.

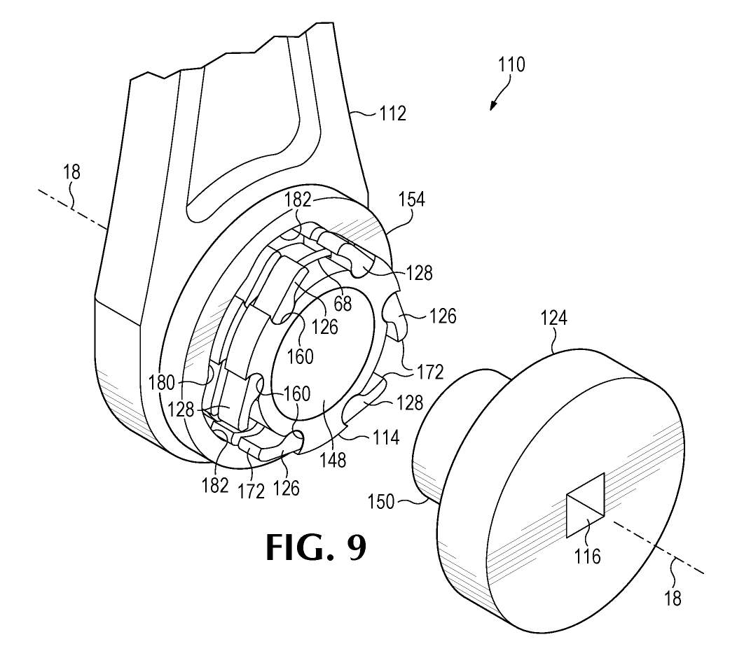

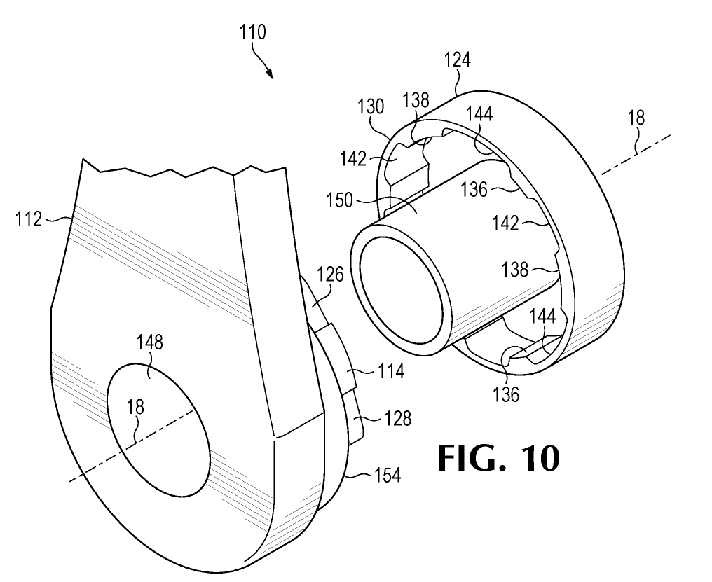

Referring next to FIGS. 9 and 10, as shown in exploded views a shaft drive mechanism 110 is shown associated with a crank arm 112. The shaft drive mechanism 110 includes a driving member 114 incorporated in an inner end of the crank arm 112 and a driven member 124 that is shown as being integral with a shaft adapter 116. It will be understood that the shaft adapter 116 could be a separate member attached to the driven member 124 if desired. The shaft drive mechanism 110 is thus similar to the shaft drive mechanism 10 described above but with the components of the driving member 14 and the driven member 24 basically exchanged with each other.

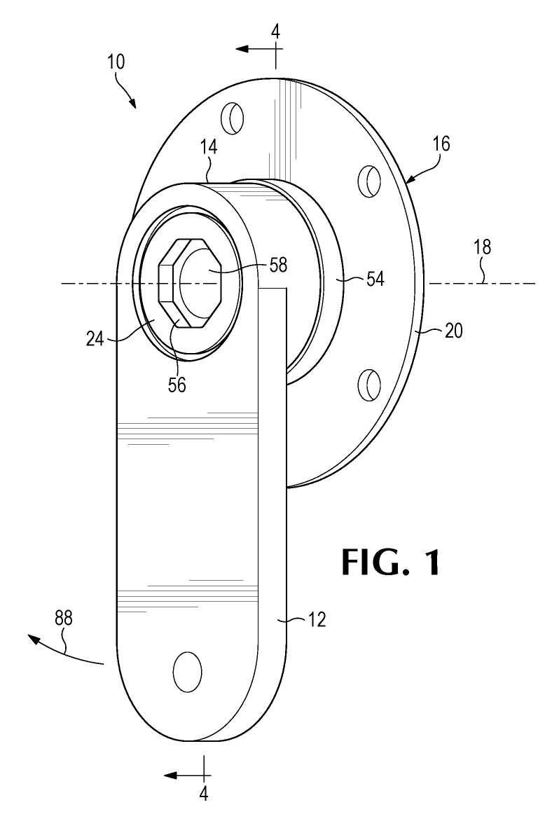

A central, generally cylindrical main body of the driving member 114 carries three pawls 126 oriented in one direction and three pawls 128 oriented oppositely, instead of the four pawls 26, 28, 30, and 32 of the shaft drive mechanism 10 shown in FIGS. 1-8. The pawls 126 and 128 are similar to the pawls 26, 28, 30, and 32 and are mounted in respective pawl receptacles 160. A spring 68 engages the pawls 126 and 128 and urges them to rotate so that their outer ends 172 protrude with respect to the main body of the driving member 114.

The driving member 114 includes an internal bearing 148, and the driven member includes a journal 150 that fits rotatably within the bearing 148 when the shaft drive mechanism 110 is fully assembled.

The driven member 124 includes a generally cylindrical outer rim portion 130 that surrounds a portion of the driving member 114 and portions of the pawls 126 and 128 when the shaft drive mechanism 110 is fully assembled. The outer rim portion 130 of the driven member 124 includes small circumferentially oriented notches 142 and larger notches 144, spaced alternatingly about the interior of the outer rim portion 130, separated by cogs 136 that can be engaged by the outer ends 172 of the pawls 126 and 130.

A control member 154, or control ring, similar to the control member 54 of the drive mechanism 10, is fitted on and rotatable with respect to a cylindrical base portion of the driving member 114. Radially inwardly protruding cams 180 are located around the periphery of the control member 154, where they can engage respective ones of the pawls 126 and 128 and prevent the outer ends 172 of those pawls from protruding radially into the notches 142 or 144 to engage the cogs 136. Spaces 182 between the cams 180 permit the outer ends 172 of respective ones of the pawls 126 and 128 to protrude radially far enough to engage the cogs 136 when the control member 154 is in a suitable position of rotation with respect to the main body of the driving member 114, in a manner similar to the relationship between the control member 54 and the driven member 24, as shown in FIGS. 6, 7, and 8 and described above.

Thus, as described above with respect to the drive mechanism 10, the control member 154 can be adjusted with respect to the driving member 114, to respective positions where the cams 180 prevent all the pawls 126 from protruding, or where the cams 180 prevent all the pawls 128 from protruding, or where all of the pawls 126 and 128 are free to protrude into the spaces 182 between the cams 180. As determined by the position of the crank arm 112 and driving member 114 with respect to the driven member 124 when the control member 154 is rotated into a selected position, the pawls 126 or 128 can protrude into respective ones of the notches 142 or 144, and the crank arm 112 can drive the driven member 124 in one direction and free-wheel in the opposite direction; drive the driven member 124 in either direction with a minimal amount of lost motion; or, with the outer ends 172 of the pawls 126 and 128 protruding into the large notches 144, drive the driven member 124 in either direction, but with a predetermined amount of angular freedom or lost motion between driving in one direction and driving in the other direction.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A rotary drive mechanism, comprising:
(a) an outer member defining an inner surface centered about an axis of rotation;
(b) an inner member located within the outer member and supported for rotation about the axis of rotation with respect to the outer member;
(c) a first pawl carried in a first one of the outer member and the inner member and oriented in a first direction with respect to the member in which it is mounted;
(d) a second pawl carried in the first one of the outer member and the inner member and oriented in a second direction opposite the first direction with respect to the member in which hit is mounted,
(e) each of the pawls being mounted so as to be able to move, between a withdrawn, disengaged, position and an extended, engaging, position with respect to a surface of the member in which it is mounted;
(f) a spring, carried on the member in which each pawl is mounted and arranged to urge each pawl toward its extended, engaging, position;
(g) a first driving cog located on the second one of the outer member and the inner member in a location in which the first driving cog can be engaged drivingly by one of the pawls in its extended position, to drive the second one of the outer member and the inner member in a first direction of rotation;
(h) a second driving cog located on the second one of the outer member and the inner member in a location in which the second driving cog can be engaged drivingly by one of the pawls in its extended position to drive the second one of the outer member and the inner member in a second direction of rotation;
(i) the first and second driving cogs being located with such an amount of angular separation about the axis of rotation that the first one of the outer member and the inner member is movable in rotation relative to the second one of the outer member and the inner member through an angular distance determined by said amount of angular separation; and
(j) a control member supported adjacent the member in which each pawl is mounted, the control member being selectively movable to and detained in a position in which the control member prevents one of the pawls from being located in its extended position.

2. The rotary drive mechanism of claim 1 wherein the first and second driving cogs are located with such an amount of angular separation that the first one of the outer member and the inner member is movable through an angular distance no greater than 3° relative to the second one of the outer member and the inner member.

3. The rotary drive mechanism of claim 1 wherein the outer member is a driving member and the inner member is a driven member.

4. The rotary drive mechanism of claim 3 wherein the first and second pawls are carried by the driven member and the first and second driving cogs are defined in the driving member.

5. The rotary drive mechanism of claim 1 wherein the inner member is a driving member and the outer member is a driven member.

6. The rotary drive mechanism of claim 5 wherein the first and second pawls are carried by the driving member and the first and second cogs are defined in the driven member.
